(19) United States
(12) Patent Application Publication
(10) Pub. No.: US 2007/0050700 A1
(43) Pub. Date: Mar. 1, 2007

(54) Formattable spreadsheet table elements with automatic updating

(75) Inventors: Roy Simkhay, Seattle, WA (US); David F. Gainer, Redmond, WA (US); Tom J. Hoke, Sammamish, WA (US); Benjamin C. Chamberlain, Redmond, WA (US); Paavany Jayanty, Bellevue, WA (US); Charles D. Ellis, Seattle, WA (US)

Correspondence Address: MICROSOFT CORPORATION;ATTN: PATENT GROUP DOCKETING DEPARTMENT, ONE MICROSOFT WAY, REDMOND, WA, 98052-6399, US

(73) Assignee: Microsoft Corporation, Redmond, WA (US)

(21) Appl. No.: 11/214,682

(22) Filed: Aug. 30, 2005

(51) Int. Cl. G06F 17/24

(52) U.S. Cl. 715/503

(57) ABSTRACT

Spreadsheets are subdivided into formattable table elements that may include multiple table cells so that the multiple table cells can be formatted as a single element. As such, a gradient format can be applied across the range of multiple table cells instead of to individual table cells. A format property can be applied to a spreadsheet table to provide alternating table element formats that are automatically updated when cells or formattable table elements are added, deleted, hidden, shown or moved. As a result, when a table modification is made, the alternating format of the table is updated before the table is rendered on a display.

### BACKGROUND

Tables are used in spreadsheets to present data to a user in an easily comprehendible and aesthetically pleasing format. One way that is frequently used to make tables more easily readable is to format alternating rows and/or columns with different background shading, background patterns, font colors, font styles, etc.

Present techniques to create alternating formatting on a spreadsheet table present some difficulties. For one, if a user manually formats the table with alternating formatting, the formatting does not update after actions such as adding, deleting, showing, hiding and/or moving table cells. Also, although alternate formatting may be applied through conditional formatting so that a table format is updated when cells are added or deleted, it is difficult to apply conditional formatting and all table format modifications cannot be taken into account.

### SUMMARY

The present disclosure describes a banding property that, when applied to a spreadsheet table, allows alternating formats to be easily applied to formattable table elements of the spreadsheet table. Formattable table elements (rows, columns, header row, totals row, etc.) can include multiple table cells so that the multiple table cells can be formatted together as a single element so that gradient formatting, shading, and the like can be applied across the range of the multiple table cells instead of each individual cell. When a structure of a table with alternating format is altered (e.g. a table row is hidden), the alternating format is automatically updated before the table is rendered.

### BRIEF DESCRIPTION OF THE DRAWINGS

The foregoing and other aspects of the subject matter disclosed herein will become more readily appreciated and will become better understood by reference to the following detailed description, when taken in conjunction with the accompanying drawings, wherein:

FIG. 1A is an illustration of an exemplary spreadsheet table with row striping.

FIG. 1B is an illustration of the exemplary spreadsheet table shown in FIG. 1A after a table row is hidden.

FIG. 2A is an illustration of an exemplary spreadsheet table with row striping.

FIG. 2B is an illustration of the exemplary spreadsheet table shown in FIG. 2A after a row has been added.

FIG. 3 is an illustration of an exemplary spreadsheet table with row striping wherein each row stripe is two (2) rows high.

FIG. 4 is an illustration of an exemplary spreadsheet table with row striping wherein each row stripe is two (2) rows high and has an outside border.

FIG. 5 is an illustration of an exemplary spreadsheet table with row striping and column striping wherein the column striping takes precedence over the row striping.

FIG. 6 is an illustration of an exemplary spreadsheet table with row and column striping and borders.

FIG. 7 is a block diagram of an exemplary system for automatic updating of formattable spreadsheet table elements.

FIG. 8 is a flow diagram depicting an exemplary methodological implementation of a process for automatically updating formattable spreadsheet table elements.

FIG. 9 is a block diagram depicting an exemplary general purpose computing device that may be used in conjunction with one or more implementations described herein.

### DETAILED DESCRIPTION

Overview

The presently described subject matter describes a spreadsheet table banding property that can be activated to implement alternate formatting of formattable table elements. “Banding” refers to the ability to format alternating table elements in different styles so as to make data in the table more easily readable. For example, alternating rows and/or columns in the body of a table may have a shaded background.

As used herein, the term “formattable table element” includes any cell or range of cells in a spreadsheet table that can be formatted as a single element. Examples of formattable table elements include, but are not limited to, table rows, table columns, header rows, total columns, etc.

Some formatting is easier to apply to a formattable table element than to the individual cells that make up the formattable table element, e.g. shading. Applying shading to a row to affect shading in all cells of the row is easier than applying shading to each individual cell. Also, some types of formatting won't work for a range of cells when applied to individual cells in that range. For example, consider gradient shading. Gradient shading applied to a range of cells provides a shade gradient from a first cell in the range to a last cell in the range. If the gradient were applied to individual cells, each cell would exhibit the complete range of the shading gradient and the desired appearance would not be achieved.

By virtue of the fact that the banding may be applied as a property of a spreadsheet table, applying banding to a table is easier than in previous spreadsheet applications. Once the property is applied with the appropriate formatting, the formatting remains with the table even after a table structure is altered. For example, if a table has alternate row shading and a row is deleted, the table is automatically updated so that the rows remain alternately shaded. In previous implementations, deletion of a non-shaded row would cause two shaded rows to appear adjacent to one another. Similar anomalies would occur when table elements were added, hidden, shown or moved.

The banding property may also be applied in a table style. Table styles are described in U.S. patent application Ser. No. ______, filed contemporaneously herewith by the present applicants, entitled “Customizable Styles for Spreadsheet Tables.” Said application is assigned to Microsoft Corp., the assignee of the present invention. When a table style incorporates a banding property, the banding property is applied to all instances of the table style unless it is removed from an instance of a table after the table is created.

These and other features of formattable spreadsheet table elements with automatic updating are described in greater detail below, with respect to the previously described figures.

Exemplary Spreadsheet Table With Row Striping—Hidden Rows

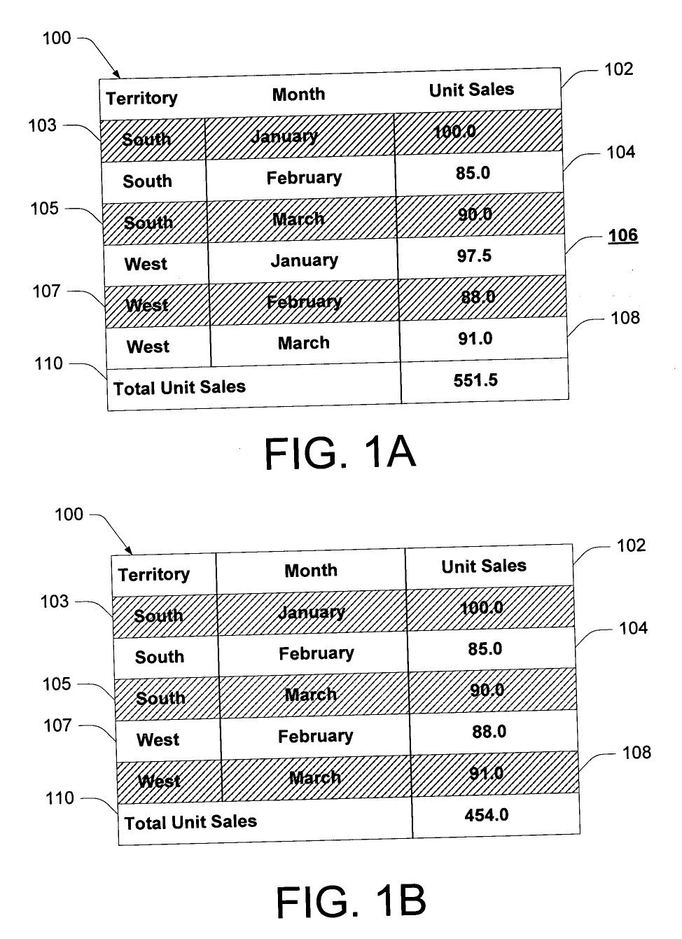

FIG. 1A is an illustration of an exemplary spreadsheet table 100 that exhibits a property of row striping. Row striping is a form of banding wherein one or more rows of one format alternate with one or more rows of another format. Similarly, column striping is a type of banding wherein one or more columns having a first format alternate with one or more columns having a second format.

The exemplary spreadsheet table 100 includes a header row 102 that includes column labels, specifically, “Territory”, “Month” and “Unit Sales”. The exemplary table 100 includes rows 103-108, wherein odd-numbered rows 103, 105, 107 are formatted with a background fill (i.e. “shading”) that is not present in the even-numbered rows 104, 106, 108. This alternate shading of rows is an example of row striping, or banding.

FIG. 1B is an illustration of the exemplary spreadsheet table 100 shown in FIG. 1A after table row 106 has been hidden. It is a common practice to filter spreadsheet table values that results in hiding particular rows, columns, etc. Here, for example, a user may have wanted to filter out partial unit sales which would eliminate row 106 because it has a unit sales value of “97.5”.

In typical spreadsheet applications, the row striping would not be maintained after the hiding of row 106 and a user would have to manually reformat the table 100 to re-effect the row striping. Here, however, the banding property associated with the exemplary spreadsheet table 100 automatically updates the row striping after the single row 106 has been hidden.

Although this particular example deals with a hidden row, other operations that result in a change in the structure of the exemplary spreadsheet table 100 causes the table 100 to be reformatted. Such other operations include showing (un-hiding), adding, deleting or moving a table element such as a row, column, etc.

Exemplary Spreadsheet Table With Row Striping—Added Rows

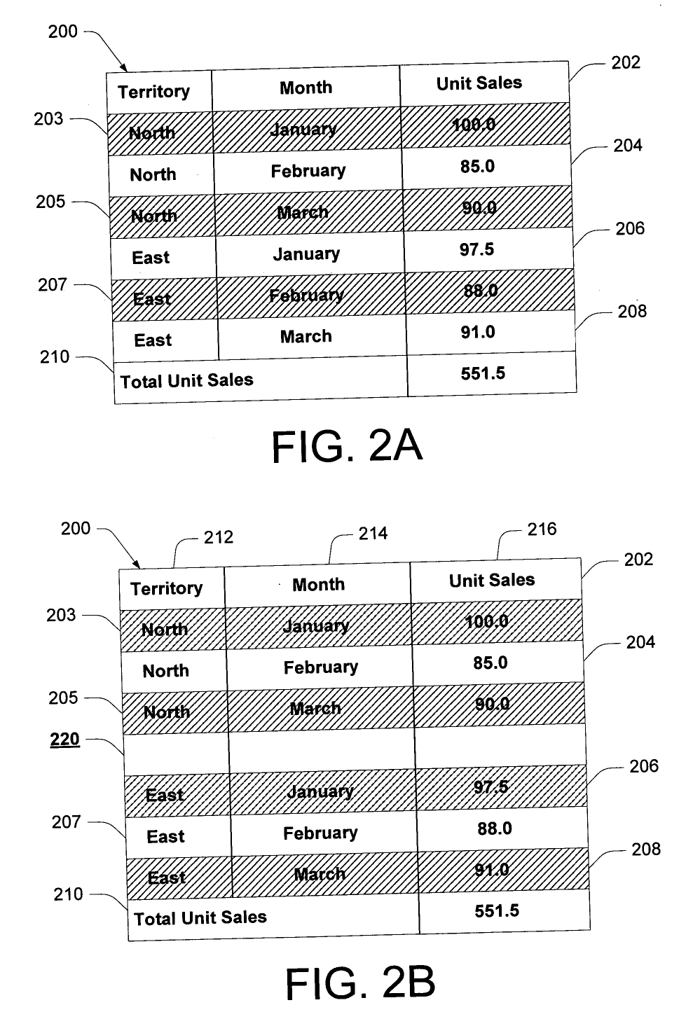

FIG. 2A is an illustration of an exemplary spreadsheet table 200 that exhibits a property of row striping. The exemplary spreadsheet table 200 includes a header row 202 that includes column labels, specifically, “Territory”, “Month” and “Unit Sales”. The exemplary table 200 includes rows 203-208, wherein odd-numbered rows 203, 205, 207 are formatted with a background fill that is not present in the even-numbered rows 204, 206, 208. The exemplary table 200 also includes a totals row 210.

FIG. 2B is an illustration of the exemplary spreadsheet table 200 shown in FIG. 2A after a new row 220 is added to the table 200. When row 220 is added, the row striping format is updated so that the alternate background fill is maintained.

It is noted that the present example deals with table rows 203-208 as a formattable element that can be formatted as a single unit. Other formattable table elements included in table 200 include the header row 202 and the totals row 210 as well as columns 212, 214, 216. Formattable table elements are described in greater detail below, with respect to subsequent figures.

Exemplary Spreadsheet Table With Multi-Row Striping

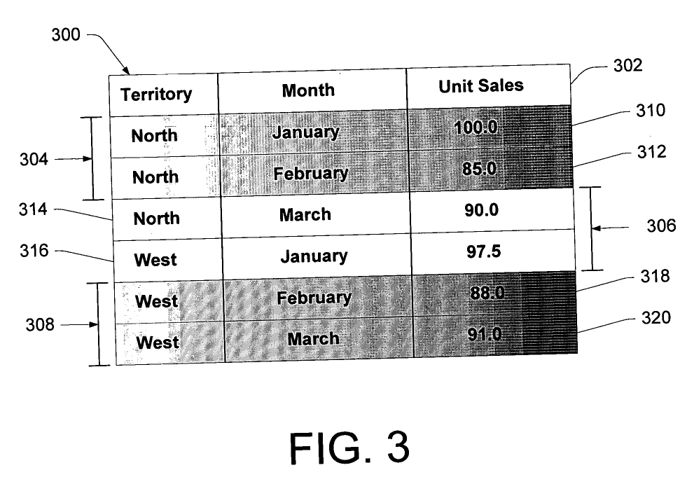

FIG. 3 is an illustration of an exemplary spreadsheet table 300 with row striping wherein each row stripe is two (2) rows high. Stripes may include any practical number of rows or columns and can be defined in the banding property associated with the table 300. Here, the banding property is applied and the stripes are configured to be two (2) rows high.

The exemplary spreadsheet table 300 includes a header row 302 and rows 310-320. Rows 310 and 312 are included in row stripe 304; rows 314 and 316 are included in row stripe 306; and rows 318 and 320 are included in row stripe 308.

This particular example shows how a gradient format can be applied across a range of table cells by applying the gradient format to a formattable table element. Here, each row stripe of two rows comprises a formattable table element. Since all table cells across each row stripe can be formatted as a single element, the gradient spans all the cells in a row instead of each individual cell.

Exemplary Spreadsheet Table with Row Striping and Borders

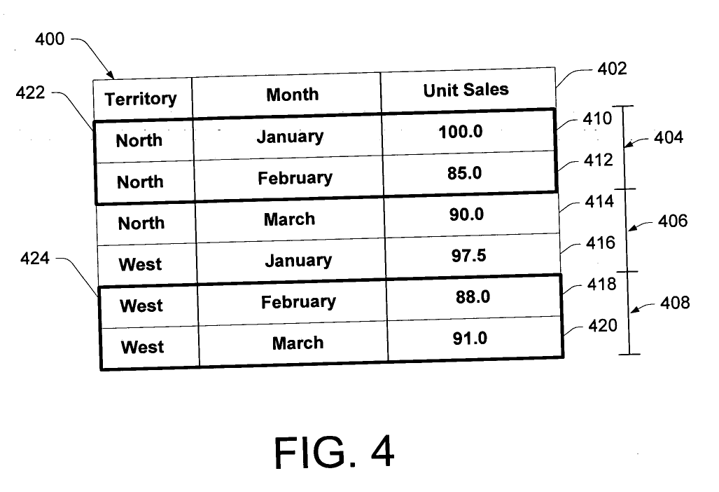

FIG. 4 is an illustration of an exemplary spreadsheet table 400 with row striping wherein each stripe is two (2) rows high and has an outside border. The exemplary spreadsheet table 400 includes a header row 402 and rows 410-420. Stripe 404 consists of rows 410 and 412; stripe 406 consists of rows 414 and 416; and stripe 408 consists of rows 418 and 420.

In the present example, a first outside border 422 surrounds stripe 404 and a second outside border 424 surrounds stripe 408. To effect this, a property associated with the exemplary table 400 is configured to format alternating stripes wherein each stripe is two (2) rows high and wherein the alternating format is denoted by a border.

Once again, the advantage of being able to format multiple table cells as a single element is clear. If only individual table cells could be formatted with a border, a border could not be placed around a row stripe without significant effort on the part of a user to format each individual cell to create a border outside each row stripe.

Here too, if the table structure were to change by way of adding a row, deleting a row, etc., the table format would be automatically updated to keep row stripes two rows high and to keep an outside border around alternating row stripes. Therefore, a user would not have to manually recreate the alternating stripes each time the table structure changed.

Exemplary Spreadsheet Table with Row Striping and Column Striping

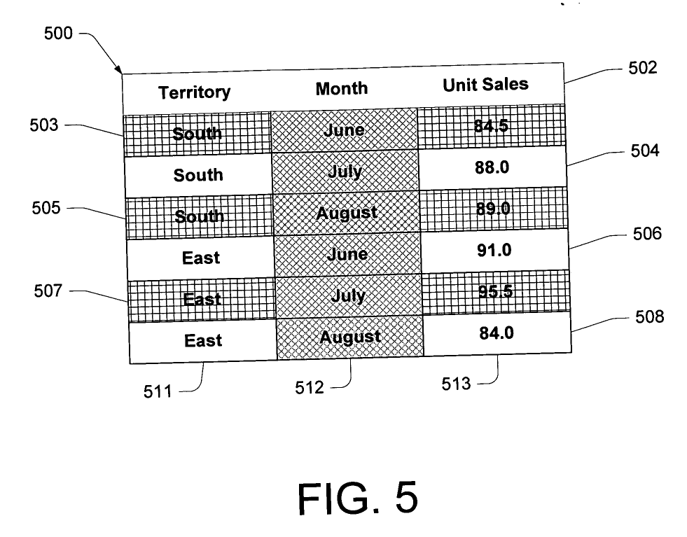

FIG. 5 is an illustration of an exemplary spreadsheet table 500 with row striping and column striping wherein the column striping takes precedence over the row striping. A formattable table element precedence order may be established as a default or may be user-definable so that when a table cell is included in more than one formattable table element, incompatible formats will not be applied to the table cell.

The exemplary spreadsheet table 500 includes a header row 502 and rows 503-508. The exemplary table 500 also includes columns 511-513. The banding property associated with the exemplary table 500 is configured for alternate row striping and alternate column striping.

In the present example, the odd-numbered rows (503, 505, 507) are formatted with a grid fill pattern that is not present in the even-numbered rows (504, 506, 508). The even-numbered column (512) is formatted with a cross-hatch fill pattern that is not present in the odd-numbered columns (511, 513).

An undesirable appearance would result if table cells included in odd-numbered rows and even-numbered columns were formatted with both the grid fill pattern and the cross-hatch fill pattern. Therefore, the banding property associated with table 500 is configured so that column formatting takes precedence over row formatting. As a result, all table cells included in column 512 include the cross-hatch fill pattern regardless of whether they are contained in a row where cells to not have a fill pattern.

It is noted that some formats may be combined, i.e. they are compatible. For example, a bold font format and an underline font format are compatible. When one formattable table element includes bold text and another formattable table element includes underlined text, table cells that are included in both formattable table elements can include bold and underlined text.

Any precedence order that is established takes format compatibility into account. Only incompatible formats need some sort of precedence order established for them.

Exemplary Spreadsheet Table with Row Striping, Column Striping & Borders

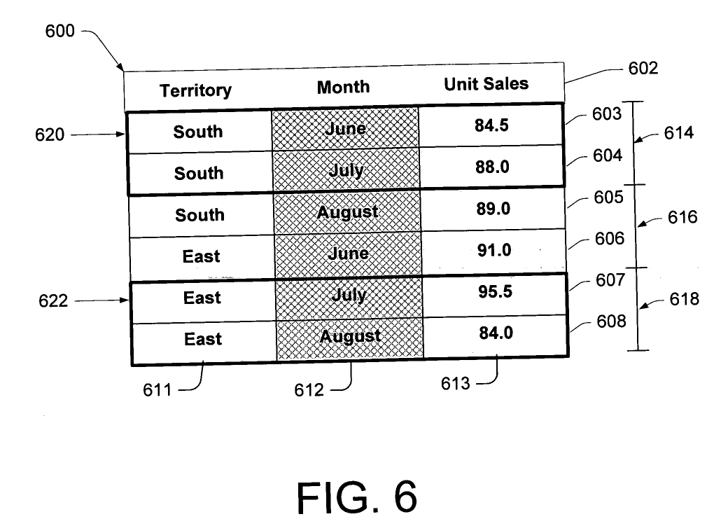

FIG. 6 is an illustration of an exemplary spreadsheet table 600 with row and column striping and borders 600. The exemplary spreadsheet table 600 is shown as an example of compatible formats for formattable table elements.

The exemplary spreadsheet table 600 includes a header row 602 and rows 603-608. The exemplary table 600 also includes columns 611-613. The table property associated with the table 600 is configured with row stripes that are two (2) rows high. Row stripe 614 consists of row 603 and row 604; row stripe 616 consists of row 605 and row 606; and row stripe 618 consists of row 607 and row 608.

The banding property of the exemplary table 600 is also configured to render an outside border around each row stripe. In the present example, border 620 appears around row stripe 614 and border 622 appears around row stripe 618.

As in the previous example, the banding property of the exemplary spreadsheet table 600 is configured to apply a column striping format over a row striping format. However, since a table cell can display the column striping format (i.e. the cross-hatch fill) and a border simultaneously without presenting an unacceptable or confusing appearance, the row striping format (i.e. an outside border) is not overridden by the column striping format (i.e. cross-hatch fill).

Exemplary Computer System and Spreadsheet Application

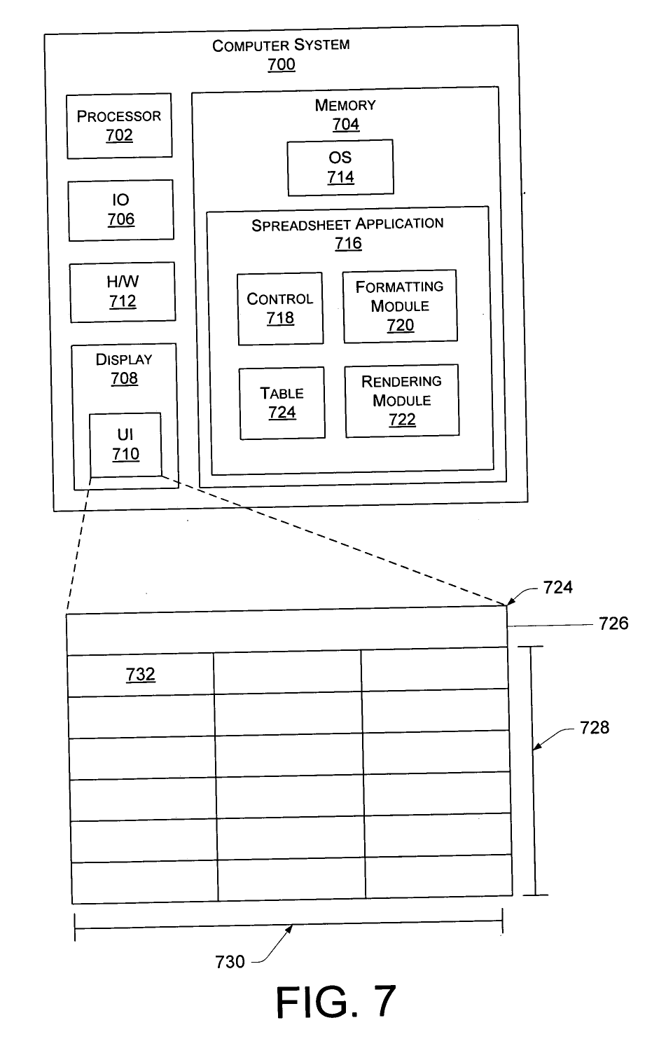

FIG. 7 is a block diagram of an exemplary computer system 700 for automatically updating formattable spreadsheet table elements. In the following example, it is noted that only elements pertinent to the present discussion are shown in detail in the exemplary system 700. Other systems may be implemented with more or fewer elements than shown in FIG. 7 without departing from the purpose of the exemplary system 700 as described herein.

Furthermore, it is noted that particular functionality is attributed to certain elements in the following discussion. Such attribution is for discussion purposes only and functions necessary to carry out the described techniques may be allocated differently among shown elements or other elements in other implementations.

The exemplary computer system 700 includes a processor 702 and memory 704. The exemplary computer system 700 also includes an input-output (IO) module 706 configured to transmit data between the computer system 700 and external devices (not shown), such as a keyboard, mouse, etc. A display 708 is shown included in the computer system 700, however the display 708 may be situated separate and apart from the computer system 700, in which case it (display 708) would communicate with the computer system 700 via the IO module 706. A user interface 710 is rendered on the display 708.

Other miscellaneous hardware components 712 are included in the exemplary computer system 700. Said hardware components 712 are hardware components typically found in computer systems and/or are necessary to facilitate the operations described herein and attributed to the computer system 700.

The memory 704 includes an operating system 714 that is configured to provide miscellaneous software applications and to control processing functionality for the computer system 700. A spreadsheet application 716 is stored in the memory 704 of the computer system 700.

The spreadsheet application 716 is configured to perform the functions described herein with respect to previous and subsequent figures. The spreadsheet application 716 includes a control module 718, a table formatting module 720 and a rendering module 722. The formatting module 720 is configured to allow a user to apply formats to formattable table elements contained in a spreadsheet table. The rendering module 722 is configured to render spreadsheets generated by the spreadsheet application 716 on the user interface 710.

A spreadsheet table 724 is stored in the memory 704 and is shown rendered on the display 708 as a part of the user interface 710. The spreadsheet table 724 includes several formattable table elements: a header row 726, table rows 728, table columns 730 and individual table cells 732 (only one individual table cell is labeled with reference numeral 732).

It is noted that some table cells 732 are included in more than one formattable table element. For example, the table cell labeled with reference numeral 732 is included in a first row 728 table element and a first column 730 table element. The control module 718 establishes a precedence order for incompatible table element formats that is applied in the event that a table cell is included in two or more formattable table elements.

Other formattable table elements that are not shown could be included in the spreadsheet table 724. These include, but are not limited to multi-row stripes, multi-column stripes, a totals row, etc. As previously discussed, each formattable table element can be formatted as a single element no matter how many table cells are included in the formattable table element.

The control module 718 is configured to allow a user to modify the structure of the spreadsheet table 724, such as by adding, deleting, hiding, showing or moving a table element 724-732. When such a modification occurs, the formatting module 720 is configured to detect the modification and to apply the subscribed formatting to the table 724. The reformatted table 724 is then rendered (via rendering module 722) on the user interface 710.

For example, if the table 724 includes row striping on alternate rows 728 and a row is deleted, the formatting module 720 reformats the table 724 so that the row striping persists on alternate rows as previously described.

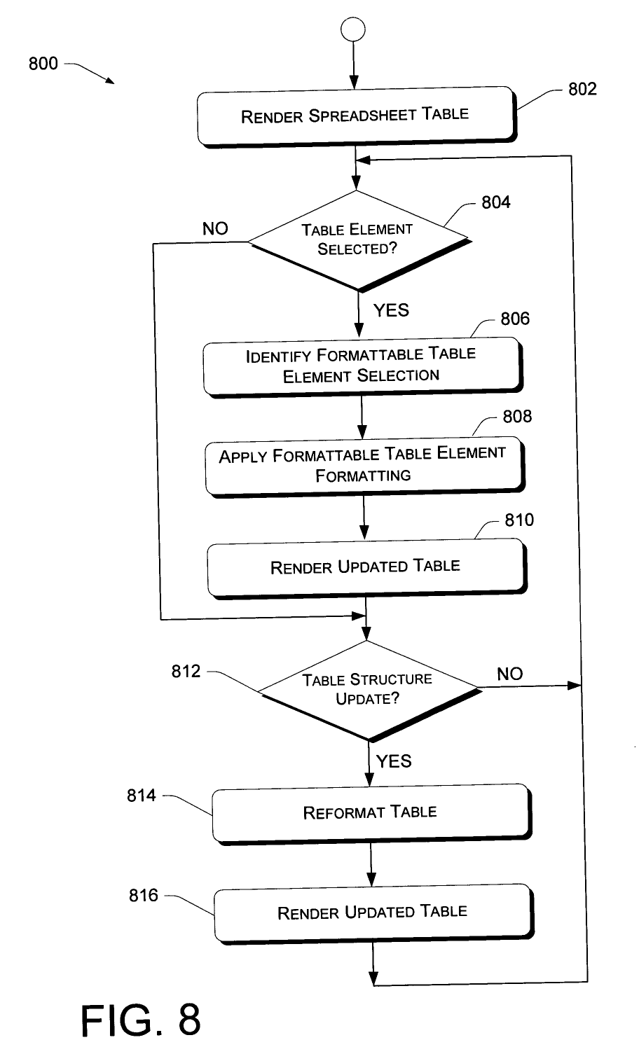

The functionality of the computer system 700 and its elements will be described in greater detail below, with respect to the methodological implementation depicted in FIG. 8 and described with respect thereto.

Exemplary Methodological Implementation

FIG. 8 is a flow diagram 800 depicting an exemplary methodological implementation of a process for automatically updating formattable spreadsheet table elements. In the following discussion, continuing reference is made to elements and reference numerals contained in previous figures. It is noted that although the steps are presented in a particular order, the described functionality may be implemented by the steps in a different order or in conjunction with one or more other steps.

At block 802, the rendering module 722 (FIG. 7) renders the spreadsheet table 724 on the user interface 710. If a formattable table element 726-732 is selected (“Yes” branch, block 804), then the formatting module 806 identifies the selected table element (block 806) and applies formatting to the selected table element at block 808 according to user commands. The rendering module 722 then renders the table 724 on the user interface 710 at block 810. If no table element selection is detected (“No” branch, block 804), then the process continues at block 812.

At block 812, the control module 718 determines if an update to the structure of the spreadsheet table 724 has been made, such as an addition, deletion, hiding, showing or moving of a formattable table element. If not (“No” branch, block 812), then the process reverts to block 804.

When a table structure update is detected (“Yes” branch, block 812), the formatting module 720 reformats the spreadsheet table 724 (block 814) and the rendering module 722 renders the updated spreadsheet table 724 at block 816.

Accordingly, the format of the spreadsheet table 724 is automatically maintained when changes are made to the table 724, thus relieving a user of the burden of manually reformatting the table 724 each time the table is modified.

Exemplary Operating Environment

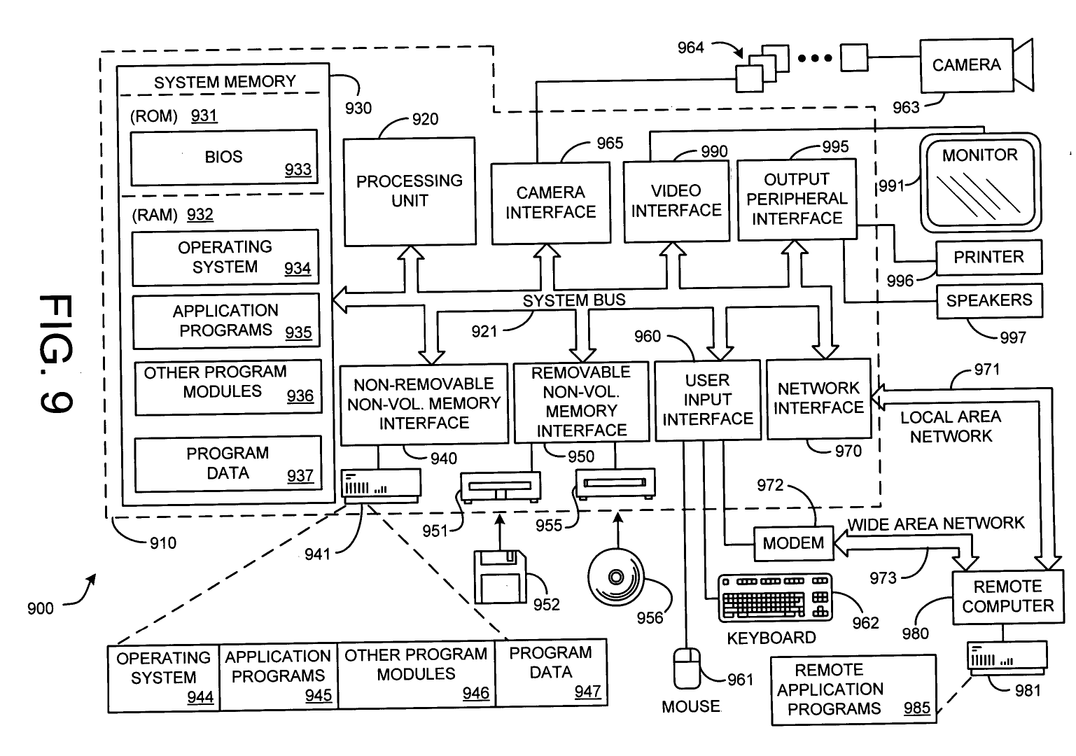

FIG. 9 is a block diagram depicting a general purpose computing environment 900 that may be used in one or more implementations according to the present description. The computing system environment 900 is only one example of a suitable computing environment and is not intended to suggest any limitation as to the scope of use or functionality of the claimed subject matter. Neither should the computing environment 900 be interpreted as having any dependency or requirement relating to any one or combination of components illustrated in the exemplary operating environment 900.

The described techniques and objects are operational with numerous other general purpose or special purpose computing system environments or configurations. Examples of well known computing systems, environments, and/or configurations that may be suitable for use include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The following description may be couched in the general context of computer-executable instructions, such as program modules, being executed by a computer. Generally, program modules include routines, programs, objects, components, data structures, etc. that perform particular tasks or implement particular abstract data types. The described implementations may also be practiced in distributed computing environments where tasks are performed by remote processing devices that are linked through a communications network. In a distributed computing environment, program modules may be located in both local and remote computer storage media including memory storage devices.

With reference to FIG. 9, an exemplary system for implementing the invention includes a general purpose computing device in the form of a computer 910. Components of computer 910 may include, but are not limited to, a processing unit 920, a system memory 930, and a system bus 921 that couples various system components including the system memory to the processing unit 920. The system bus 921 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 910 typically includes a variety of computer readable media. Computer readable media can be any available media that can be accessed by computer 910 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 910. Communication media typically embodies computer readable instructions, data structures and/or program. Combinations of the any of the foregoing should also be included within the scope of computer readable media.

The system memory 930 includes computer storage media in the form of volatile and/or nonvolatile memory such as read only memory (ROM) 931 and random access memory (RAM) 932. A basic input/output system 933 (BIOS), containing the basic routines that help to transfer information between elements within computer 910, such as during start-up, is typically stored in ROM 931. RAM 932 typically contains data and/or program modules that are immediately accessible to and/or presently being operated on by processing unit 920. By way of example, and not limitation, FIG. 9 illustrates operating system 934, application programs 935, other program modules 936, and program data 937.

The computer 910 may also include other removable/non-removable, volatile/nonvolatile computer storage media. By way of example only, FIG. 9 illustrates a hard disk drive 941 that reads from or writes to non-removable, nonvolatile magnetic media, a magnetic disk drive 951 that reads from or writes to a removable, nonvolatile magnetic disk 952, and an optical disk drive 955 that reads from or writes to a removable, nonvolatile optical disk 956 such as a CD ROM or other optical media. Other removable/non-removable, volatile/nonvolatile computer storage media that can be used in the exemplary operating environment include, but are not limited to, magnetic tape cassettes, flash memory cards, digital versatile disks (DVD), digital video tape, solid state RAM, solid state ROM, and the like. The hard disk drive 941 is typically connected to the system bus 921 through a non-removable memory interface such as interface 940, and magnetic disk drive 951 and optical disk drive 955 are typically connected to the system bus 921 by a removable memory interface, such as interface 950.

The drives and their associated computer storage media discussed above and illustrated in FIG. 9, provide storage of computer readable instructions, data structures, program modules and other data for the computer 910. In FIG. 9, for example, hard disk drive 941 is illustrated as storing operating system 944, application programs 945, other program modules 946, and program data 947. Note that these components can either be the same as or different from operating system 934, application programs 935, other program modules 936, and program data 937. Operating system 944, application programs 945, other program modules 946, and program data 947 are given different numbers here to illustrate that, at a minimum, they are different copies. A user may enter commands and information into the computer 910 through input devices such as a keyboard 962 and pointing device 961, commonly referred to as a mouse, trackball or touch pad. Other input devices (not shown) may include a microphone, joystick, game pad, satellite dish, scanner, or the like. These and other input devices are often connected to the processing unit 920 through a user input interface 960 that is coupled to the system bus 921, but may be connected by other interface and bus structures, such as a parallel port, game port or a universal serial bus (USB). A monitor 991 or other type of display device is also connected to the system bus 921 via an interface, such as a video interface 990. In addition to the monitor, computers may also include other peripheral output devices such as speakers 997 and printer 996, which may be connected through an output peripheral interface 995. A camera 963 (such as a digital/electronic still or video camera, or film/photographic scanner) capable of capturing a sequence of images 964 can also be included as an input device to the personal computer 910. Further, while just one camera is depicted, multiple cameras could be included as an input device to the personal computer 910. The images 964 from the one or more cameras are input into the computer 910 via an appropriate camera interface 965. This interface 965 is connected to the system bus 921, thereby allowing the images to be routed to and stored in the RAM 932, or one of the other data storage devices associated with the computer 910. However, it is noted that image data can be input into the computer 910 from any of the aforementioned computer-readable media as well, without requiring the use of the camera 963.

The computer 910 may operate in a networked environment using logical connections to one or more remote computers, such as a remote computer 980. The remote computer 980 may be a personal computer, a server, a router, a network PC, a peer device or other common network node, and typically includes many or all of the elements described above relative to the computer 910, although only a memory storage device 981 has been illustrated in FIG. 9. The logical connections depicted in FIG. 9 include a local area network (LAN) 971 and a wide area network (WAN) 973, but may also include other networks. Such networking environments are commonplace in offices, enterprise-wide computer networks, intranets and the Internet.

When used in a LAN networking environment, the computer 910 is connected to the LAN 971 through a network interface or adapter 970. When used in a WAN networking environment, the computer 910 typically includes a modem 972 or other means for establishing communications over the WAN 973, such as the Internet. The modem 972, which may be internal or external, may be connected to the system bus 921 via the user input interface 960, or other appropriate mechanism. In a networked environment, program modules depicted relative to the computer 910, or portions thereof, may be stored in the remote memory storage device. By way of example, and not limitation, FIG. 9 illustrates remote application programs 985 as residing on memory device 981. It will be appreciated that the network connections shown are exemplary and other means of establishing a communications link between the computers may be used.

### CONCLUSION

While one or more exemplary implementations have been illustrated and described, it will be appreciated that various changes can be made therein without departing from the spirit and scope of the claims appended hereto.

1. A method, comprising:
rendering a spreadsheet table on a user interface, said spreadsheet table including at least one formattable table element that is formatted according to a specific format;
detecting a structural update in the spreadsheet table that affects the specific format of the formattable table element;
automatically reformatting the formattable table element to comply with the specific format for the formattable table element; and
rendering the spreadsheet table on the user interface to reflect the reformatted formattable table element and the structural update.

2. The method as recited in claim 1, wherein:
the at least one formattable table element further comprises a first formattable table element and a second formattable table element; and
the format of the first formattable table element takes precedence over the format of the second formattable table element when the reformatted table elements are rendered on the user interface.

3. The method as recited in claim 2, wherein:
the first formattable table element further comprises rows;
the second formattable table element further comprises columns; and
the format of the first formattable table element and the second formattable table element further comprise alternating stripes.

4. The method as recited in claim 1, wherein the formattable table element further comprises multiple table cells that are formattable as a single element.

5. The method as recited in claim 4, wherein the formatting of the formattable table element further comprises at least a gradient formatting, the gradient being applied across all of the multiple table cells in the formattable table element.

6. The method as recited in claim 1, wherein the formattable table element further comprises a formattable table element selected from the following formattable table elements: a single row; multiple rows; a single column; multiple columns; a header row; a totals row; a single table cell; multiple table cells.

7. One or more computer-readable media containing executable instructions that, when executed, implement the following steps:
rendering a first formattable table element in a spreadsheet table, the first formattable table element including multiple table cells formatted according to a particular format;
rendering a second formattable table element in the spreadsheet table, the second formattable table element including multiple table cells formatted according to a particular format;
receiving instructions to change a structure of the spreadsheet table that will affect at least one of the formattable table elements;
automatically reformatting each affected formattable table element according to the particular format associated with the affected formattable table element; and
rendering the spreadsheet table to reflect the reformatted formattable table elements and the change in the table structure.

8. The one or more computer-readable media as recited in claim 7, wherein the multiple table cells included in each formattable table element are formatted as a single element.

9. The one or more computer-readable media as recited in claim 8, wherein at least one of the formattable table elements further comprises at least a gradient formatting, the gradient being applied across all of the multiple table cells in the formattable table element.

10. The one or more computer-readable media as recited in claim 7, wherein the first formattable table element further comprises a header row.

11. The one or more computer-readable media as recited in claim 8, further comprising a third formattable table element configured as a totals row.

12. The one or more computer-readable media as recited in claim 7, wherein the formattable table elements are selected from the following list of formattable table elements: a single row; multiple rows; a single column; multiple columns; a header row; a totals row; a single table cell; multiple table cells.

13. The one or more computer-readable media as recited in claim 7, wherein the format of the first formattable table element is applied to a table cell that is included in the first formattable table element and the second formattable table element.

14. A system, comprising:
a user interface;
rendering means for rendering a spreadsheet table on the user interface, the spreadsheet table having a structure and including at least one formattable table element;
means for detecting an update in the table structure that affects at least one formattable table element;
table formatting means for automatically formatting each formattable table element included in the spreadsheet table when a table structure update is detected; and
wherein the rendering means is further configured to render the spreadsheet table to show the table structure update and the reformatted formattable table elements.

15. The system as recited in claim 14, wherein each of the at least one formattable table elements further comprises multiple table cells that are formatted as a single element when the formattable table element is formatted.

16. The system as recited in claim 15, wherein the multiple table cells are formatted according to a gradient format that is applied across the multiple table cells.

17. The system as recited in claim 14, wherein the at least one formattable table element includes at least one of the following formattable table elements: a single row; multiple rows; a single column; multiple columns; a header row; a totals row; a single table cell; multiple table cells.

18. The system as recited in claim 14, wherein the at least one formattable table element further comprises at least two formattable table elements that each contain at least one common table cell.

19. The system as recited in claim 18, wherein the formatting means is further configured to apply formatting according to a first formattable table element instead of formatting according to a second formattable table element when a precedence order of formatting indicates that the first formattable table element takes precedence over the second formattable table element.

20. The system as recited in claim 14, wherein the table structure update further comprises at least one of the following operations: add formattable table element; delete formattable table element; hide formattable table element; show formattable table element; move formattable table element.
